(19) United States
(12) Patent Application Publication
(10) Pub. No.: US 2026/0305686 A1
(43) Pub. Date: Oct. 8, 2026

(54) An Aerosol-Generating System with a Replaceable Filter Rod

(71) Applicant: JT International SA, Geneva (CH)

(72) Inventors: Layth Sliman Bouchuiguir, Bellevue (CH); Pier Paolo Monticone, Schwyz (CH)

(73) Assignee: JT International SA, Geneva (CH)

(21) Appl. No.: 19/490,250

(22) PCT Filed: Jun. 18, 2024
(86) PCT No.: PCT/EP2024/066923

§ 371 Date: Dec. 4, 2025

(30) Foreign Application Priority Data
Jun. 19, 2023 (EP) 23180041

(51) Int. Cl. A24D 1/20; A24D 3/17; A24F 40/20; A24F 40/53; G06F 16/38

(52) U.S. Cl. CPC A24D 1/20; A24D 3/17; A24F 40/53; G06F 16/381; A24F 40/20; G06F 2212/178

(57) ABSTRACT

An aerosol-generating system which comprises an aerosol-generating article and a heat-not-burn aerosol-generating device. The aerosol-generating article may comprise an aerosol-generating rod and a replaceable filter rod. On a first end of the replaceable filter rod a connector may be disposed. A mouthpiece may be disposed at a second end of the replaceable filter rod. A filter element may be located between the connector and the mouthpiece. The replaceable filter rod may comprise a computer-readable medium to store and retrieve the information related to the usage and/or identity of the replaceable filter rod. The connector of the filter rod may be detachably attached to the proximal end of the aerosol-generating rod.

### CROSS-REFERENCE TO RELATED APPLICATIONS

The present application is a national phase entry under 35 U.S.C. § 371 of International Application No. PCT/EP2024/066923 filed Jun. 18, 2024, published in English, which claims priority from European Application No. 23180041 filed Jun. 19, 2023, the disclosures of which are incorporated herein by reference.

### FIELD OF THE TECHNOLOGY

The present invention relates to an aerosol-generating system which comprises an aerosol-generating article and a heat-not-burn aerosol-generating device, wherein the aerosol-generating article comprises an aerosol-generating rod and a replaceable filter rod. On a first end of the replaceable filter rod a connector is disposed and comprises a connecting means and at least one air inlet. A mouthpiece is disposed at a second end of the replaceable filter rod and comprises at least one air outlet. A filter element is located in between the connector and the filter cap. The replaceable filter rod also comprises a computer-readable medium with the purpose to store data and to retrieve the information related to the usage and/or identity of the replaceable filter rod. According to the invention, the connector of the filter rod is configured for multiple use by being detachably attached to the proximal end of the aerosol-generating rod via the connecting means of the connector. The number of uses is monitored by the heat-not-burn aerosol-generating device as it uses internal data such as the running time of the device and/or the change of the aerosol-generating rod and the data of the computer-readable medium like a unique filter identification number. The main purpose of this invention is to prevent misuse of the filter rod and to ensure the usual filtering effect. A consumer warning on the heat-not-burn aerosol-generating device and/or disabling the functionality of the heat-not-burn aerosol-generating device are possible measures.

### BACKGROUND

Conventional aerosol-generating articles comprise a cylindrical aerosol-generating rod generally including a tobacco material and a cylindrical filter rod. The aerosol-generating rod and the filter rod may be surrounded by a wrapping paper such that these rods are arranged in the wrapping paper to form the aerosol-generating article in the form of a stick. Typically, the filter rod includes one or more segments of cellulose acetate tow material. Once the aerosol-generating article is consumed the aerosol-generating article is discarded, sometimes in the environment by a user. The filters comprising cellulose acetate tow material, however, do not readily degrade in an ordinary environment. In order to reduce the negative environmental impact when the aerosol-generating article is discarded, biodegradable polymers, such as polylactic acid (PLA) or paper filters have been proposed as an alternative material for filters.

Another approach may be to reduce the volume of filter rods to be discarded after heat-not-burn sticks are consumed. Provision of a filter that can be used for multiple vaping sessions with different aerosol-generating articles may be effective for dealing with the reduction of the waste of filter rods, thereby contributing to produce more environmentally compatible aerosol-generating articles. In this case, the filter rod may be a replaceable filter rod configured such that the filter rod is detachably attached to one end of an aerosol-generating rod. After consumption of the aerosol-generating rod, the replaceable filter can be detached from the end of the aerosol-generating rod, and it can be attached to another aerosol-generating rod for a new vaping session.

For safely implementing the reusable filter-rod technology, it is important to prevent users from using the filter rod more than a maximum number of uses intended for the filter rod. It would therefore be desirable to provide an aerosol-generating system configured to count the number of uses of the replaceable filter rod. It is also desirable to an aerosol-generating system that alarms and/or prevent users from misusing the filter rod for more than predetermined maximum number of uses.

Today customers use an aerosol-generating article which is consisting of the filter rod and the aerosol-generating rod. Such articles can be used in heat-not-burn aerosol-generating devices. The aerosol-generating articles, respectively their refill packs, are bulky to transport for the customer and due to the combination of several materials in one component difficult to recycle.

From document WO2019140574A1 a detachable filter tip is known which includes a smoking material and a filter tip connected to each other through a partition. The filter tip can be used multiple times and the smoke material can be directly replaced each time it is used. This filter is described as a simple filter with no connector or filter cap included. It also has no functionality to monitor the usage and to prevent misuse of the filter element.

Document CN103271444A discloses an electronic filter holder with an alarm function, an electronic counter, a clock device and a filter tip. The electronic filter holder is configured to record the number of cigarettes consumed per day to alarm the customer. No change of filter or filter rod is intended.

Document US 2014/261486 A1 discloses a vapor-enhancing apparatus for an electronic vapor smoking article, which is operably engaged with a filter material and is configured to enhance the vapor drawn through the filter material.

Document U.S. Pat. No. 10,390,562 B2 discloses an electronic smoking article, which includes a liquid aerosol formulation, a heater operable to volatilize the liquid aerosol formulation and form an aerosol, and at least one frangible or crushable flavor bead at least partially.

Document US 2022/039478 A1 discloses an aerosol-generating device. It comprises a detection element for detecting a type of mouthpiece and a controller for controlling the use of the device.

The state of the art systems feature a replaceable aerosol-generating rod that contain a firmly fixed filter rod. When the aerosol is smoked, the entire aerosol-generating rod must be replaced. Some documents describe detachable filter elements, but these simple filter elements cannot prevent misuse of the filter, such as overuse. Moreover, the full usability and safety standards of the filter rod and the entire heat-not-burn aerosol-generating device must be secured, so measures must be taken to stop the heat-not-burn aerosol-generating device when the filter rod is fully loaded.

### SUMMARY OF THE INVENTION

The objective of the invention is therefore to improve the usability of an aerosol-generating article in terms of a more compact design of the refill packs and thus a more handy transport of the refill packs by the customer, a reduction of the production costs and, above all, an easier recycling of the used aerosol-generating articles in order to contribute to the protection of the environment. The full functionality of the replaceable filter rod is achieved by monitoring the use of the replaceable filter rod and taking appropriate measures when the maximum usage time is reached.

It has been found that these problems could be overcome by an aerosol-generating system according to claim 1 and a method according to claim 8.

According to the invention, the replaceable filter rod for the aerosol-generating article for use with the heat-not-burn aerosol-generating device of the aerosol-generating system comprises a first and a second end. On the first end the connector is disposed and comprises a connecting means and at least one air inlet. A mouthpiece is disposed at the second end of the replaceable filter rod and comprises at least one air outlet. The filter element is located in between the connector and the filter cap. The replaceable filter rod also comprises a computer-readable medium. The purpose of the computer-readable medium is to store data and to retrieve the information related to the usage and/or identity of the replaceable filter rod. According to the invention, the connector of the filter rod is configured for multiple use by being detachably attached to the proximal end of the aerosol-generating rod via the connecting means of the connector. This design ensures easy attachment and detachment of the filter rod and the aerosol-generating rod by the customer as the connector of the filter rod is designed to ensure stable fixation and disconnection of filter rod and aerosol-generating rod at least for the intended number of uses. Preferably, the number of uses is monitored by the heat-not-burn aerosol-generating device as it uses internal data such as the running time of the device and/or the change of the aerosol-generating rod and the data of the computer-readable medium like a unique filter identification number. The main purpose of this invention is to prevent misuse of the filter rod and to ensure the usual filter effect. A consumer notice on the heat-not-burn aerosol-generating device and/or a stop of the functionality of the heat-not-burn aerosol-generating device are possible measures.

According to a preferred embodiment of the aerosol-generating system, the replaceable filter rod that is used in the aerosol-generating article is provided with a readable and/or re-writable medium comprising a RFID tag. The RFID tag can be fixed to the filter construction by means of an adhesive medium or can be fixed under a thin layer, or it can be a RFID flexible sticker tag configured to be adhered on the exterior surface. Also fastening of the RFID tag by a clamp connection can be advantageous. The RFID tag can be used to communicate relevant data to the heat-not-burn aerosol-generating device. This can be the type of filter or an individual filter ID to ensure, that the use of the filter can be monitored. After a certain number of uses, the heat-not-burn aerosol-generating device may have a functionality to stop an ongoing heating process of the aerosol generating article and/or prevent the start of new heating processes unless the filter is changed. When the data reader in the heat-not-burn aerosol-generating device receives a new filter ID it can unlock the device again. In another preferred embodiment where the RFID tag is not only readable but re-writable, the number of uses of a particular filter can be stored on the RFID tag of the replaceable filter rod. This prevents misuse, as a fully loaded filter cannot be used on another heat-not-burn aerosol-generating device.

The RFID tag is designed to be read when the tag is very close to the reader, this application requires data to be sent over a short distance. Preferably, the readable or re-writable medium includes or is a NFC (near field communication), as NFC is preferred for short-range communication. Nevertheless, the RFID tag can also be any other type of RFID, such as an RFID Glass tag.

In another preferred embodiment the complexity of the replaceable filter rod of the aerosol-generating system is reduced by replacing the RFID tag by a readable optical code, such as two-dimensional QR codes and barcodes. The advantage of this embodiment is that the readable optical code can be imprinted on the filter rod. Not only the reduction of complexity and costs, but also the simplified disposal can be favorable.

According to another preferred embodiment of the aerosol-generating system, the computer readable medium of the replaceable filter rod comprises one or more magnets. The magnetic force can be evaluated by a receiver in the heat-not-burn aerosol-generating device to distinguish between different replaceable filter rods. This embodiment can also secure, that the time of use can be monitored and the heat-not-burn aerosol-generating device can have a functionality to stop unless the filter is changed.

In a preferred embodiment of the aerosol-generating system, the connector of the replaceable filter rod is designed as a thread cut. This thread cut connector serves as a detachable connection to an aerosol-generating rod. In this embodiment, the connector is designed to cut a suitable counter thread in the aerosol-generating rod. In another preferred embodiment, the aerosol-generating rod shows already a corresponding counter-thread. In both embodiments the aerosol-generating rod is fastened or screwed into the connector by screwing the connector in the aerosol-generating rod.

Preferably, the aerosol-generating rod of the aerosol-generating system is pressed or clamped into the connector. In this case, it is important to ensure that the customer can easily fix the connector without damaging the components.

In another preferred embodiment of the aerosol-generating system the connector of the replace-able filter rod is designed as a press fit. The fitting of the mating parts, connector of the replace-able filter rod and the aerosol-generating rod, is tighter than a sliding fit. This is used to have no relative movement of the mentioned above parts during use but to have the option to change the replaceable filter rod. It is also conceivable that the connector is fixed and held to the aerosol-generating rod with magnets. In this case the connector of the replaceable filter rod contains a magnet, and the aerosol-generating rod comprises a magnetic material. It is also possible that the connector of the replaceable filter rod contains magnetic material, e.g. iron and the aerosol-generating rod carries a magnet. In another preferable embodiment the fit of the connector of the replaceable filter rod and the aerosol-generating rod is made with elastic materials such as Silicone rubber. In this preferred embodiment a type of press fit is produced, as the elastic material such as silicon rubber material is a deformable mass that molds to the aerosol-generating rod, when it is pressed into the connector of the replaceable filter rod.

Preferably, the material of the filter cap of the replaceable filter rod of the aerosol-generating system is PEEK (Polyether ether ketone), ceramic or other solid materials. Different substances can be used as filter material, all of them must show a good filter effect over a longer period of use, compared to a filter for single use only. Cotton, cellulose or active charcoal are preferred materials to filter the aerosol. The individual components of the replaceable filter rod, namely the connector, the filter element and the filter cap, are preferably held together by a filter construction. Preferably, this is made of rigid paper, glass, ceramic or PEEK.

In a preferred embodiment of the aerosol-generating system the RFID tag of the replaceable filter rod is a RFID Glass tag. In another preferred embodiment the RFID tag is a flexible sticker tag which is adhered on an exterior surface of the replaceable filter rod. There are many possible variations of RFID tags and the placement on the replaceable filter rod. All have the same purpose, to store or transmit data to the device.

Therefore in another preferred embodiment of the aerosol-generating system the RFID tag of the replaceable filter rod can be an NFC tag (near field communication tag). This embodiment is preferred because the tag and reader can be arranged side by side in this system.

In a further preferred embodiment of the aerosol-generating system, the RFID tag is arranged in the replaceable filter rod. This shows the advantage that it does not have to be attached after production in a further work step but can already be inserted during assembly in one of the first steps. In addition, it is housed in a tamper-proof manner.

According to the invention, the aerosol-generating article of the aerosol-generating system consists of at least a replaceable filter rod and an aerosol-generating rod, wherein the replaceable filter rod and the aerosol-generating rod are designed to be separable from each other. The replaceable filter rod is detachable from the aerosol generating rod and can be attached to a new aerosol generating rod by means of the connector. In the present state of the art the aerosol-generating article for the aerosol-generating system is arranged to be indivisible. The disadvantage of this embodiment is that the aerosol-generating article is larger and more unwieldy than the aerosol-generating rod only. Therefore, a refill pack is also more unhandy. When the refill pack consists of several aerosol-generating rods which comprise the aerosol-generating substrate, but only one replaceable filter rod, that can be used for several aerosol-generating rods, the refill pack can be designed much handier, and the transport is much more comfortable for the customer. Another advantage of the separate design of the components is an easier recycling, as the replaceable filter rod and the aerosol-generating rod are designed to be easily separated and therefore to be recycled separately.

According to the invention, the aerosol-generating system is designed to comprise the aerosol-generating article and the heat-not-burn aerosol-generating device. The heat-not-burn aerosol-generating device of this system comprises a heating cavity which is configured to receive at least a portion of the aerosol-generating article to be heated. A heater element in the system is configured to heat the aerosol-generating article, which is received in the heating cavity. The data reader is configured to detect the computer-readable media and to receive and to store the signal indicative of the data related to the replaceable filter rod of the aerosol-generating article when the aerosol-generating article is inserted in the heating cavity.

In another preferable embodiment the heater element is configured to heat the aerosol-generating article received in the heating cavity. A data receiver is configured to detect the computer-readable media and to receive the signal indicative of the data related to the replaceable filter rod of the aerosol-generating article while the aerosol-generating article is inserted in the heating cavity. As described above, the data related to the replaceable filter rod can be used to monitor the use of the filter and to stop the functionality unless the filter is changed.

In another preferred embodiment of an aerosol-generating system the data receiver of the heat-not-burn aerosol-generating device is located adjacent to a wall of the heating cavity. This design allows the data receiver to communicate with the computer-readable media while the aerosol-generating article is inserted in the heating cavity of the heat-not-burn aerosol-generating device. This preferred arrangement of the components facilitates the communication as the transmission path is optimized.

The communication and detection does not have to take place all the time but can also take place only during the insertion process of the aerosol generating article into the aerosol-generating device. In another preferred embodiment, the communication is triggered when the aerosol generating article is inserted and/or removed into or out of the aerosol-generating device. These embodiments show the advantage that communication does not have to take place during the entire period of use. This is advantageous with respect to the power consumption of the aerosol generating device. At the beginning or the end of the vaporization session, the re-writable medium, preferably a RFID tag or NFC tag, can be written with the number of previous uses. After a certain number of uses, the device will indicate that the filter needs to be changed. Not only the number of uses, but also the duration of vaping or the time the unit is switched on can be transmitted and used to monitor the filter.

In addition to the number of times the filter has been used, the re-writable medium can also store other information such as the type of stick (e.g. flavour) and manufacturing information (e.g. date, traceability) that is transmitted to the device. The device can further process this information by sending the filter ID to a server. Data sent back to the device from the server can then change the settings for the detected flavour, for example.

Alternatively, the medium is not writable, and the device stores the number of times the filter has been used via the unique ID of the filter and does not allow the vaping function of the device to be switched on when the number of uses has reached a predetermined number.

Preferably the aerosol-generating system comprises a control circuitry connected to the data receiver which is configured to determine the usage information of the replaceable filter rod based on the signal received by the data receiver.

According to another preferable embodiment, the aerosol-generating system is designed such that the control circuit of the heat-not-burn aerosol-generating device is configured to identify the replaceable filter rod and to determine the number of uses of the replaceable filter rod based on the signal received by the receiver. With this embodiment the aerosol-generating system can process the information and configure the system to optimize the use for the customer.

According to a preferable embodiment, the aerosol-generating system and preferably also the control circuitry of the heat-not-burn aerosol-generating device is configured to deactivate or turn off the heater when the usage information of the replaceable filter rod reaches or exceeds a pre-determined value, this prevents the customer to use a fully loaded filter with reduced filter effectiveness. This ensures that the aerosol, the customer inhalants, is always of a stable and desired quality.

According to a preferred embodiment, the aerosol-generating system comprises a control circuitry of the heat-not-burn aerosol-generating device that is configured to provide a user notification when the usage information of the replaceable reaches or exceeds a pre-determined value. This ensures, that the customer is aware of the status of the system and that he can carry out a filter change.

The objective of the invention is also solved by a method to operate the aerosol-generating system according to claim 8. The method comprises a structured sequence of steps.

First, the aerosol-generating rod must be coupled to the connector of the filter rod to form the aerosol-generating article. Second, the aerosol-generating article must be inserted into the heating cavity of the heat-not-burn aerosol-generating device to form an aerosol-generating system. In a next step the computer readable or re-writable medium in the replaceable filter rod is detected by the data reader of the heat-not-burn-device. The data is counted and/or evaluated, to switch off the heat-not-burn aerosol-generating device and or to provide a user notification and/or alarm when a predetermined data value of the filter load is reached.

In a preferred embodiment, the replaceable filter rod is detected during the insertion of the aerosol-generating article into the heat-not-burn aerosol-generating device.

Preferably, the replaceable filter rod can also be detected during the insertion and the removal of the aerosol-generating article.

In another preferred embodiment, the replaceable filter rod is detected during the whole period in which the aerosol-generating article is placed in the heating cavity.

Preferably, the control circuitry of the heat-not-burn aerosol-generating device identifies the replace-able filter rod during or after the detection of the computer readable or re-writable medium. Preferably the control circuitry determines the number of uses of the replaceable filter rod based on the signal received by the data receiver.

According to a preferred embodiment, the time period in which the replaceable filter rod is arranged in the heating cavity is recorded. Alternatively its overall duration of use is recorded.

Preferably, the control circuitry of the heat-not-burn aerosol-generating device provides a user notification when the data received from the computer readable or re-writable medium of the replaceable filter rod reaches or exceeds a predetermined value.

### BRIEF DESCRIPTION OF THE DRAWINGS

Further advantages, objectives and features of the present invention will be described, by way of example only, in the following description with reference to the appended figures. In the figures, like components in different embodiments can exhibit the same reference symbol.

The figures show:

FIG. 1 Schematic view of an embodiment of a replaceable filter rod and an embodiment of an aerosol-generating rod.

FIG. 2 Schematic few of an embodiment of the filter rod which comprises a readable or a re-writable medium comprising a RFID tag.

FIG. 3 Schematic view of an embodiment of the filter rod which comprises an QR-code.

FIG. 4 Schematic view of an embodiment of an aerosol generating system which comprises an aerosol-generating article and a heat-not-burn aerosol-generating device.

FIG. 5 Schematic view of an embodiment of a filter cap.

FIG. 6 Schematic view of an embodiment of a filter cap.

FIG. 7 Schematic view of an embodiment of a filter cap.

FIG. 8 Schematic view of the connector of the filter rod and the aerosol-generating rod.

### DETAILED DESCRIPTION

FIG. 1 shows the cross-sectional view of an embodiment of the replaceable filter rod 1 and an embodiment of the aerosol-generating rod 8. The combination of both parts constitutes an aerosol-generating article 11. The filter rod 1 contains the filter element 6 inside the filter construction 7. The filter cap 5 is arranged on the second end 3 of the filter element 6 and the connector 4 is arranged on the first end 2. The filter cap 5 is used as a mouthpiece through which the user inhales the aerosol medium. The connector 4 is used to connect the filter element 6 to the aerosol-generating rod 8. The connector 4 can have a wide variety of shapes. In one advantageous embodiment it is designed as a thread cut. Another beneficial embodiment is a connector with a pressed fit or magnetic means. Also an elastic material such as Silicone rubber is a type of connector that is a feasible design.

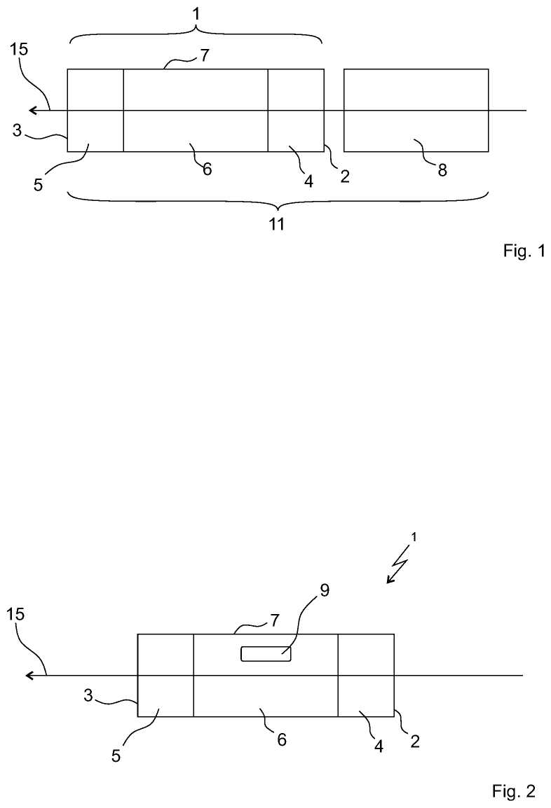

FIG. 2 shows the cross-sectional view of an embodiment of the replaceable filter rod 1 with the RFID tag 9 comprised the filter construction 7. This RFID tag 9 is designed to carry data, which can be read by a data reader 17 in the heat-not-burn aerosol-generating device 12. In another embodiment, the RFID tag 9 is not only implemented as a read only device, but also as a read and write device to store new or different data before, during or after the use of the replaceable filter rod 1 in the heat-not-burn aerosol-generating device 12. The RFID tag 9 can be attached to the inner or outer surface of the replaceable filter rod 1 or be suspended in the volume of the replaceable filter rod 1. Furthermore the RFID tag 9 can be a NFC tag.

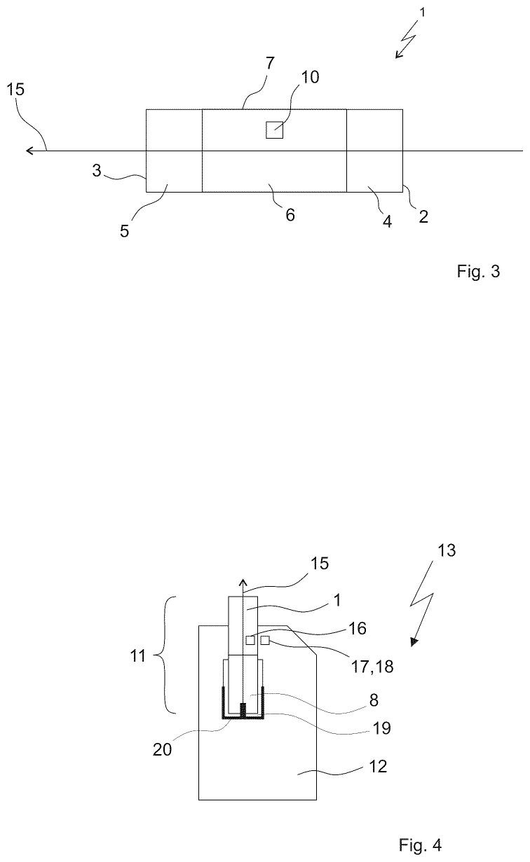

FIG. 3 shows the cross-sectional view of the replaceable filter rod 1 with an QR code 10 attached to the filter construction 7. This QR code is a two-dimensional code that contains data. In this design it contains data about the filter rod. This data can be read by the data reader 17 which is a QR code scanner in this embodiment, thus the heat-not-burn aerosol-generating device 12 receives the data, stored in the QR code 10 of the filter rod 1.

FIG. 4 shows the schematic view on the aerosol generating system 13. This assembly comprises the aerosol-generating article 11 and the heat-not-burn aerosol-generating device 12, which comprises a heating cavity 19 configured to receive at least a portion of the aerosol-generating article 11 to be heated and a heater element 20 configured to heat the aerosol-generating article 11 received in the heating cavity 19. The aerosol-generating article 11 consists of two units, the replaceable filter rod 1 and the aerosol-generating rod 8, which comprises an aerosol-generating substrate. The aerosol is generated in the aerosol-generating rod 8 by heating and flows through the aerosol-generating rod 8 in the direction of flow 15. A computer readable and/or rewritable medium 16 is attached to the replaceable filter rod 1. A data transmitter 18 for the data of the readable and/or rewritable medium 16 is arranged in the heat-not-burn aerosol-generating device 12. The data transmitter 18 in the device is positioned so that the computer readable medium 16 in the replaceable filter rod 1 comes within the range where the data transmitter 18 can detect the computer readable medium 16, when the tobacco rod is fully inserted into the heating cavity.

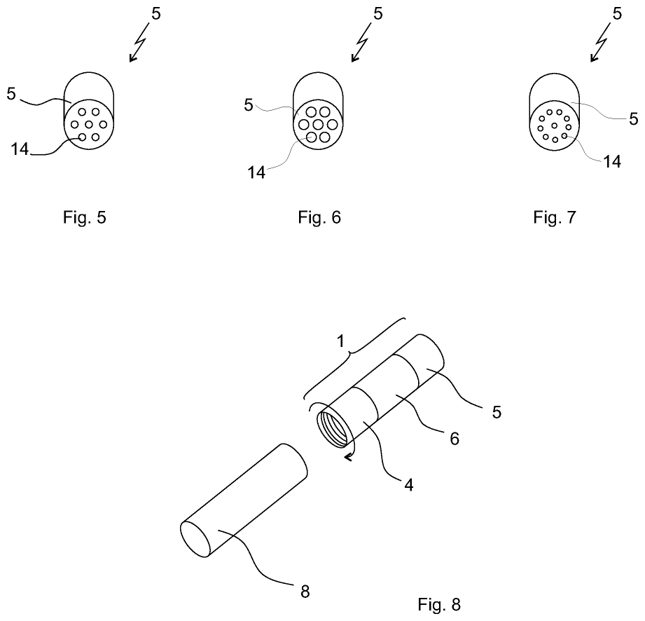

FIGS. 5 to 7 show different embodiments of the filter cap 5. The filter cap 5 is part of the replaceable filter rod 1 and is the last element of the replaceable filter rod 1 in the direction of flow. It is therefore the mouthpiece of the replaceable filter rod 1. This filter cap 5 can be of different types. Both material and shape can vary. For example, the material can be made of ceramics or a plastic such as PEEK. The outer shape of the filter cap 5 is generally cylindrical. To influence the flow, the holes 14 through which the customer inhales the aerosol can be of different shapes. Both the number and the diameter of the holes 14 can influence the flow resistance. The holes 14 are optimized so that the customer has a pleasant feeling when inhaling the aerosol and does not have to inhale too hard on the replaceable filter rod 1. FIG. 5 therefore shows a design with a total of 7 holes 14 through which the aerosol can flow from the aerosol-generating rod 8 through the connector 4 and the filter element 6 and then be inhaled by the customer. FIG. 6 shows a design with 7 holes 14 larger in their respective diameter compared to the embodiment of FIG. 5. As described, this creates less flow resistance. FIG. 7 shows a design with a total of 9 holes 14 through which the aerosol can flow. Although the holes 14 are smaller than in the designs described in FIGS. 5 and 6, the total area of the opening can be increased by the number of holes 14, thus optimizing the flow resistance. Different combinations of the number of holes 14 and their diameters are possible. Designs with different hole diameters in one element are also conceivable.

FIG. 8 shows the schematic view of the connector 4 of the replaceable filter rod 1 and the aerosol-generating rod 8. In this embodiment, the connector 4 is designed as a thread cur. The connector 4 has a type of internal thread or cutting thread. The aerosol-generating rod 8 is fastened or screwed into the connector 4 by screwing the connector 4 in the aerosol-generating rod 8, this preferably requires half a turn. This only describes one way to insert the connector 4. Any other method, such as press-fitting, clamping, fastening with magnets or silicone molding, is possible.

### LIST OF REFERENCE SYMBOLS

1 replaceable filter rod
2 first end
3 second end
4 connector
5 filter cap
6 filter element
7 filter construction
8 aerosol-generating rod
9 RFID tag
10 QR-Code
11 aerosol-generating article
12 heat-not-burn aerosol-generating device
13 aerosol-generating system
14 hole
15 flow direction
16 computer readable and/or re-writable medium
17 data reader
18 data transmitter
19 heating cavity
20 heater element

1. An aerosol-generating system comprising:
an aerosol-generating article,
comprising:
an aerosol-generating rod; and
a replaceable filter rod,
comprising a first end, a second end, a connector disposed at the first end, the connector comprising at least one air inlet, a filter cap disposed at the second end comprising at least one air outlet, a filter element that is located in between the connector and the filter cap,
wherein the connector is detachably connectable to a proximal end of the aerosol-generating rod and, wherein the replaceable filter rod comprises a computer-readable and/or re-writable medium for storing data for retrieving the information related to usage and/or identity of the replaceable filter rod, and
wherein the replaceable filter rod is detachable from the aerosol generating rod and can be attached to a new aerosol generating rod by the connector; and
the a heat-not-burn aerosol-generating device comprising:
a heating cavity configured to receive at least a portion of the aerosol-generating article to be heated and a heater element configured to heat the aerosol-generating article received in the heating cavity; and
a data reader configured to detect the computer-readable and/or re-writable medium and to receive and to store the signal indicative of the data related to the replaceable filter rod of the aerosol-generating article when the aerosol-generating article is inserted in the heating cavity.

2. The aerosol-generating system according to claim 1, wherein the data reader of the heat-not-burn aerosol-generating device is arranged adjacent to a wall of the heating cavity such that the data reader is able to communicate with the computer-readable and/or re-writable medium when the aerosol-generating article is inserted in the heating cavity of the heat-not-burn aerosol-generating device.

3. Th aerosol-generating system, according to claim 1, wherein the computer-readable and/or re-writable medium of the replaceable filter rod comprises a RFID tag.

4. The aerosol-generating system according to claim 1, wherein, characterized that the computer-readable and/or re-writable medium of the replaceable filter rod comprises one or more machine-readable optical codes.

5. The aerosol-generating system according to claim 1, wherein the computer-readable and/or re-writable medium of the replaceable filter rod comprises one or more magnets.

6. The aerosol-generating system according to claim 1, wherein the connector of the replaceable filter rod comprises a thread cut, a pressed fit, a magnet, and/or elastic material.

7. The aerosol-generating system according to claim 3, wherein the RFID tag of the replaceable filter rod is a NFC tag.

8. A method for operation of the aerosol-generating system according to claim 1, the method comprising:
a) coupling the aerosol-generating rod to the connector of the filter rod to form the aerosol-generating article,
b) inserting the aerosol-generating article into the heating cavity of the heat-not-burn aerosol-generating device to form an aerosol-generating system,
c) detecting the computer readable or re-writable medium in the replaceable filter rod by the data reader of the heat-not-burn-device,
d) counting and/or evaluating the data, and
e) switch off the heat-not-burn aerosol-generating device and or provide a user notification and/or alarm when a predetermined data value of the filter load is reached.

9. The method according to claim 8, wherein the replaceable filter rod is detected during the insertion of the aerosol-generating article into the heat-not-burn aerosol-generating device.

10. The method according to claim 8, wherein the replaceable filter rod is detected during the insertion and the removal of the aerosol-generating article into and out of the heat-not-burn aerosol-generating device.

11. The method according to claim 8, wherein the replaceable filter rod is detected during a period in which the aerosol-generating article is placed in the heating cavity.

12. The method according to claims 8, wherein, during or after the detection of the computer-readable and/or re-writable medium the control circuitry of the heat-not-burn aerosol-generating device identifies the replaceable filter rod and determines the number of uses of the replaceable filter rod based on the signal received by the data reader.

13. The method according to claim 8, wherein a time period in which the reusable filter rod is arranged in the heating cavity and/or its overall duration of use is recorded.
